(19) United States
(12) Patent Application Publication
(10) Pub. No.: US 2017/0046745 A1
(43) Pub. Date: Feb. 16, 2017

(54) METHOD AND SYSTEM FOR PROVIDING RELEVANT ADVERTISEMENTS

(71) Applicant: EXCALIBUR IP, LLC., Sunnyvale, CA (US)

(72) Inventors: Delu Zhu, Beijing (CN); Zhi Xu, Beijing (CN); Lei Wu, Beijing (CN)

(73) Assignee: EXCALIBUR IP, LLC, Sunnyvale, CA (US)

(21) Appl. No.: 14/437,271

(22) PCT Filed: Apr. 3, 2015
(86) PCT No.: PCT/CN2015/075881

§ 371 Date: Apr. 21, 2015

(51) Int. Cl. G06Q 30/02; H04L 29/08

(52) U.S. Cl. CPC G06Q 30/0269; H04L 67/306

(57) ABSTRACT

The present teaching relates to providing an advertisement to a user. In one example, data associated with the user are obtained through a plurality of platforms. One or more advertisements accessed by the user are determined based on the data. A user profile associated with the user is created based on the one or more advertisements and the platforms. One of the platforms through which the user is accessing the network is detected. An advertisement is provided to the user based on the user profile and the detected platform.

### BACKGROUND

1. Technical Field

The present teaching relates to methods, systems, and programming for advertisements. Particularly, the present teaching is directed to methods, systems, and programming for providing a relevant advertisement to a user.

2. Discussion of Technical Background

The advancement in the Internet has made it possible to provide advertisements to users through the Internet. The users' interests are one of the most valuable signals that can be leveraged for selecting relevant advertisements. Because a user is most likely to act on advertisements that match his/her interests, an advertiser desires to reach out to people who are most interested in advertised products or services.

Most existing techniques for targeted advertisement try to estimate users' interest from their past behaviors and web activities, such as page and advertisement clicks, or rules that govern selection of advertisements based on users' demographic information such as location, age, occupation, etc. In addition, the estimate is based on a single web site, a single device, or a single application interacted by a user. Thus, the estimate is often inaccurate, such that users receiving web advertisements provided based on the estimate may have negative attitudes towards the advertisements and just ignore them.

Therefore, there is a need to develop techniques to provide a relevant advertisement to a user to overcome the above drawbacks.

### SUMMARY

The present teaching relates to methods, systems, and programming for advertisements. Particularly, the present teaching is directed to methods, systems, and programming for providing a relevant advertisement to a user.

In one example, a method, implemented on a machine having at least one processor, storage, and a communication platform connected to a network for providing an advertisement to a user is disclosed. Data associated with the user are obtained through a plurality of platforms. One or more advertisements accessed by the user are determined based on the data. A user profile associated with the user is created based on the one or more advertisements and the platforms. One of the platforms through which the user is accessing the network is detected. An advertisement is provided to the user based on the user profile and the detected platform.

In a different example, a system having at least one processor, storage, and a communication platform connected to a network for providing an advertisement to a user is disclosed. The system comprises a user behavior detector, an event consuming module, a web service module, an ad request analyzer, and an ad selector. The user behavior detector is configured for obtaining data associated with the user through a plurality of platforms. The event consuming module is configured for determining one or more advertisements accessed by the user based on the data. The web service module is configured for creating a user profile associated with the user based on the one or more advertisements and the platforms. The ad request analyzer is configured for detecting one of the platforms through which the user is accessing the network. The ad selector is configured for providing an advertisement to the user based on the user profile and the detected platform.

Other concepts relate to software for implementing the present teaching on providing a relevant advertisement to a user. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having information recorded thereon for providing an advertisement to a user is disclosed. The information, when read by the machine, causes the machine to perform the following. Data associated with the user are obtained through a plurality of platforms. One or more advertisements accessed by the user are determined based on the data. A user profile associated with the user is created based on the one or more advertisements and the platforms. One of the platforms through which the user is accessing the network is detected. An advertisement is provided to the user based on the user profile and the detected platform.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for providing an advertisement to a user, according to an embodiment of the present teaching;

FIG. 2 is a high level depiction of another exemplary networked environment for providing an advertisement to a user, according to an embodiment of the present teaching;

FIG. 3 illustrates an exemplary diagram of a publisher, according to an embodiment of the present teaching;

FIG. 4 is a flowchart of an exemplary process performed by a publisher, according to an embodiment of the present teaching;

FIG. 5 illustrates an exemplary diagram of a demand-side platform system, according to an embodiment of the present teaching;

FIG. 6 is a flowchart of an exemplary process performed by a demand-side platform system, according to an embodiment of the present teaching;

FIG. 7 illustrates an exemplary diagram of an event consuming module, according to an embodiment of the present teaching;

FIG. 8 is a flowchart of an exemplary process performed by an event consuming module, according to an embodiment of the present teaching;

FIG. 9 illustrates an exemplary diagram of a web service module, according to an embodiment of the present teaching;

FIG. 10 is a flowchart of an exemplary process performed by a web service module, according to an embodiment of the present teaching;

FIG. 11 illustrates exemplary structures of a user profile database and an ad metadata store, according to an embodiment of the present teaching;

FIG. 12 illustrates an exemplary user interface for providing advertisements previously accessed by a user to the user, according to an embodiment of the present teaching;

FIG. 13 illustrates an exemplary user interface for providing a preference of advertisements associated with a user, according to an embodiment of the present teaching;

FIG. 14 illustrates an exemplary user interface for a user to customize his/her preference of advertisements, according to an embodiment of the present teaching;

FIG. 15 depicts the architecture of a mobile device which can be used to implement a specialized system incorporating the present teaching; and

FIG. 16 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of providing a relevant advertisement to a user, realized as a specialized and networked system by utilizing one or more computing devices (e.g., mobile phone, personal computer, etc.) and network communications (wired or wireless). The method and system as disclosed herein aim at providing an advertisement to a user in an effective and efficient manner.

One of the goals of advertisements is to sell a product and/or a service to users. The user is more likely to pay attention to, or interact with, an advertisement if the advertised product and/or service are of interest to the user. For example, a user interested in chess will be more likely to look at an advertisement for a book about chess strategies than a user interested in, e.g., soccer. Thus, one of the elements in presenting relevant advertisements to users is to decipher user interests.

In general, multiple methodologies can be used for deciphering user interests. One of the ways is to estimate users' interest from their past behaviors, like history of products and/or services purchased by the users. Another way is to decipher interests of users based on the users' browsing context, i.e. content pages visited by users and/or their actions while viewing the content.

Disclosed herein are methods and systems for providing relevant advertisements to users based on interest information provided by the users themselves. No one can know users' interests better than the users themselves. Instead of passively waiting for advertisements based on estimates of their interests, users may want to cherry pick some advertisements they were interested in and positively define advertisements to be displayed to them.

The system disclosed in the present teaching may collect advertisements clicked by a user from different platforms (Mobile Phone, Tablet, PC, etc.) within a user-defined time period. Then, the system can provide a user interface for the user to view their clicked advertisements from different platforms, e.g. by number of ad clicks and/or length of time in ad view. The user can organize his/her clicked ads by setting categories and filters, e.g. regarding what kind of advertisements the user is interested in on what website and/or during what time. Then, the system can select and provide advertisements based on the user's ads categories and filters, such that the user can get more ads of their interested products during web activities.

The system in the present teaching enables customers of a publisher to manage ads directly and take an active part in advertisements published by the publisher. In this way, the customers will feel in charge of ads display and have positive attitude towards ads during web surfing.

In one embodiment, the system disclosed in the present teaching may include a demand-side platform (DSP), i.e. a system that allows buyers of digital advertising inventory to manage multiple advertisement exchange and data exchange accounts through one interface. Advertisers can utilize a DSP to buy ad impressions or spaces for display, video, mobile, and search advertisements, e.g. through a real-time bidding process.

The system may create an advertisement market to organize clicked advertisements and display them to users in a pleasant and personalized manner. In this market, users can handle advertisements they clicked in a more positive way; and advertisers can get more advertisement views, clicks and conversion from the users. The system can engage users' initiative in ads activities and allow the users to show their interests proactively.

Based on the presenting teaching, users may obtain information about their clicked ads from different platforms, specify their personal ads preferences, and keep out of ads annoying to them; advertisers may target users more precisely and reduce useless ads display; and the DSP can obtain user preference data with high quality and provide better services to both users and advertisers.

The terms “ad” and “advertisement” maybe used interchangeably herein. The terms “ads” and “advertisements” maybe used interchangeably herein.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

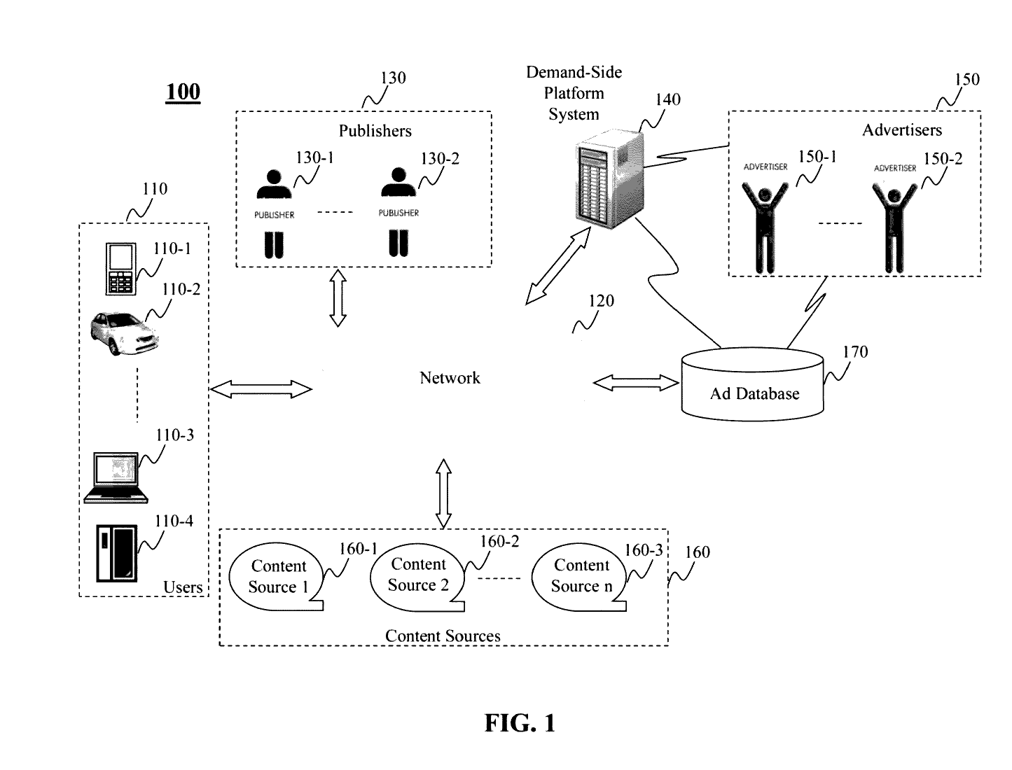

FIG. 1 is a high level depiction of an exemplary networked environment 100 for providing an advertisement to a user, according to an embodiment of the present teaching. In FIG. 1, the exemplary networked environment 100 includes one or more users 110, a network 120, one or more publishers 130, a demand-side platform system 140, one or more advertisers 150, an ad database 170, and content sources 160. The network 120 may be a single network or a combination of different networks. For example, the network 120 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 120 may be an online advertising network or ad network that is a company connecting advertisers to web sites that want to host advertisements.

Users 110 may be of different types such as users connected to the network 120 via desktop computers 110-4, laptop computers 110-3, a built-in device in a motor vehicle 110-2, or a mobile device 110-1. In one embodiment, users 110 may be connected to the network 120 and able to access and interact with online content provided by the publishers 130 through wired or wireless technologies and related operating systems implemented within user-wearable devices (e.g., glasses, wrist watch, etc.). A user, e.g., the user 110-1, may send a request for online content to one of the publishers, e.g., 130-1, via the network 120 and receive content through the network 120.

Publishers 130, may correspond to an entity, whether an individual, a firm, or an organization, having publishing business, such as a television station, a newspaper issuer, a web page host, an online service provider, or a game server. For example, in connection to an online or mobile ad network, publishers 130-1 . . . 130-2 can be an organization such as USPTO.gov, a content provider such as CNN.com and Yahoo.com, or a content-feed source such as tweeter or blogs. In one embodiment, publishers 130 include entities that develop, support and/or provide online content via mobile applications (e.g., installed on smartphones, tablet devices, etc.).

The terms “content provider” and “publisher” maybe used interchangeably herein and refer to an entity that provides or publishes electronic content to be accessed by users of a network. Content may include, for example, graphics, data, news, articles, software-based products, and so forth. A content provider may or may not provide the software used to access the content. A content provider may, in some instances refer to an entity that merely provides electronic content. In other instances, a content provider may refer to an entity that, alternatively or additionally, creates and/or distributes electronic content. Thus, in some instances, the term “publisher” may particularly refer to a content provider that provides content created by a third party for access by users. Examples of content providers include, but are not limited to, online news providers (e.g., The New York Times, The Wall Street Journal, Reuters, CNN, etc.), blogs (Tumblr, The Huffington Post, The Daily Beast, The Daily Caller, Tech Crunch, etc.), online game providers (e.g., Gaikai, OnLive, Playcast Media Systems, Zynga, etc.), massive online open courses (or MOOCs, e.g., Coursera, SlideRule, Khan Academy, Udemy, etc.), entertainment websites (e.g., ESPN, Hulu, Netflix, etc.), online database providers (e.g., IMDb, Wikipedia, etc.), content aggregators (e. g, Drudge Report, Squidoo, Slashdot, eHow, etc.), web portals (e.g., Yahoo!, Aol, Rediff, MSN, etc.), media hosting services (e.g., Youtube, Vimeo, GoFish, Veoh, etc.) and so forth.

Referring to the above example, the content sent to user 110-1 may be generated by the publisher 130-1 based on the content sources 160. A content source may correspond to an entity where the content was originally generated and/or stored. For example, a novel may be originally printed in a magazine, but then posted online at a web site controlled by a publisher. The content sources 160 in the exemplary networked environment 100 include multiple content sources 160-1, 160-2 . . . 160-3.

When content is sent to the user 110-1, one or more advertising opportunities may be available for one or more advertisements to be presented with the content to the user 110-1, on a same web page, via a same application, or in a same user session. For an available advertising opportunity, an ad request may be sent out to advertisers to ask for advertisements and sell the advertising opportunity. A group of advertisers can utilize a DSP to buy the advertising opportunity or impression. In one embodiment, the ad request may include a bid request, such that the publisher 130-1 can sell the advertising opportunity by soliciting bids from one or more DSPs. The process may then include a real-time online bidding, typically within 100 milliseconds from a user visiting a website.

The demand-side platform system 140 may serve as one DSP for buying one or more advertisement opportunities, on behalf of the advertisers 150. After receiving an ad request for an advertisement from the publisher 130-1, the demand-side platform system 140 may identify the user to whom the advertisement will be presented. The demand-side platform system 140 may retrieve a user profile created for the user and select an advertisement for the user based on the user profile. The user profile may include information about the user's preferences regarding advertisements based on delivery time, ad category, ad position, platform of the user's device, etc. The user profile may be created and updated based on the user's previously clicked advertisements and explicit input regarding the user's interest of advertisements. To update the user profile, the demand-side platform system 140 may provide to the user a user interface including advertisements previously clicked or viewed by the user on different platforms, i.e. at different web sites, on different devices, via different operating systems, via different applications, and/or using different browsers. The user can input his/her preference regarding advertisements via the user interface, based on the advertisements previously clicked or viewed by the user. The input may indicate e.g. what category of ads should be presented on what days. The demand-side platform system 140 may then update the user profile for the user based on the input.

After selecting the advertisement based on the updated user profile, the demand-side platform system 140 may retrieve the advertisement from the ad database 170 and send it to the publisher 130-1. In one embodiment, the demand-side platform system 140 may send metadata related to the advertisement to the publisher 130-1, e.g. an ad identity (ID) associated with the advertisement. After the publisher 130-1 receives the ad ID and selects the demand-side platform system 140 based on an online bidding process, the publisher 130-1 may either retrieve the advertisement via the demand-side platform system 140 or directly from the ad database 170, based on the ad ID.

In one example, a plurality of advertisement opportunities is available for presenting a plurality of advertisements in a same user session and/or related to same online content, e.g. a same web page, a same online service, a same online application, or a same online game. In this example, the plurality of advertisements can be selected and optimized in a coordinated manner based on the user's profile.

An advertiser, e.g. 150-1, may correspond to an entity, whether an individual, a firm, or an organization, doing or planning to do (or otherwise involved in) advertising business. As such, an advertiser 150-1 may be an entity that provides product(s) and/or service(s), and itself handles the advertising process for its own product(s) and/or service(s) at a platform (e.g., websites, mobile applications, etc.) provided by a publisher. For example, advertisers 150-1 . . . 150-2 may include companies like General Motors, Best Buy, or Disney. In some other cases, however, an advertiser 150-1 may be an entity that only handles the advertising process for product(s) and/or service(s) provided by another entity.

In one embodiment, the advertisers 150 have stored their advertisements at the ad database 170 or at the demand-side platform system 140 that serves as a buyer agent for the advertisers 150. The ad database 170 in this embodiment includes advertisements associated with the advertisers 150. The ad database 170 may be connected to the demand-side platform system 140, the advertisers 150, and the network 120.

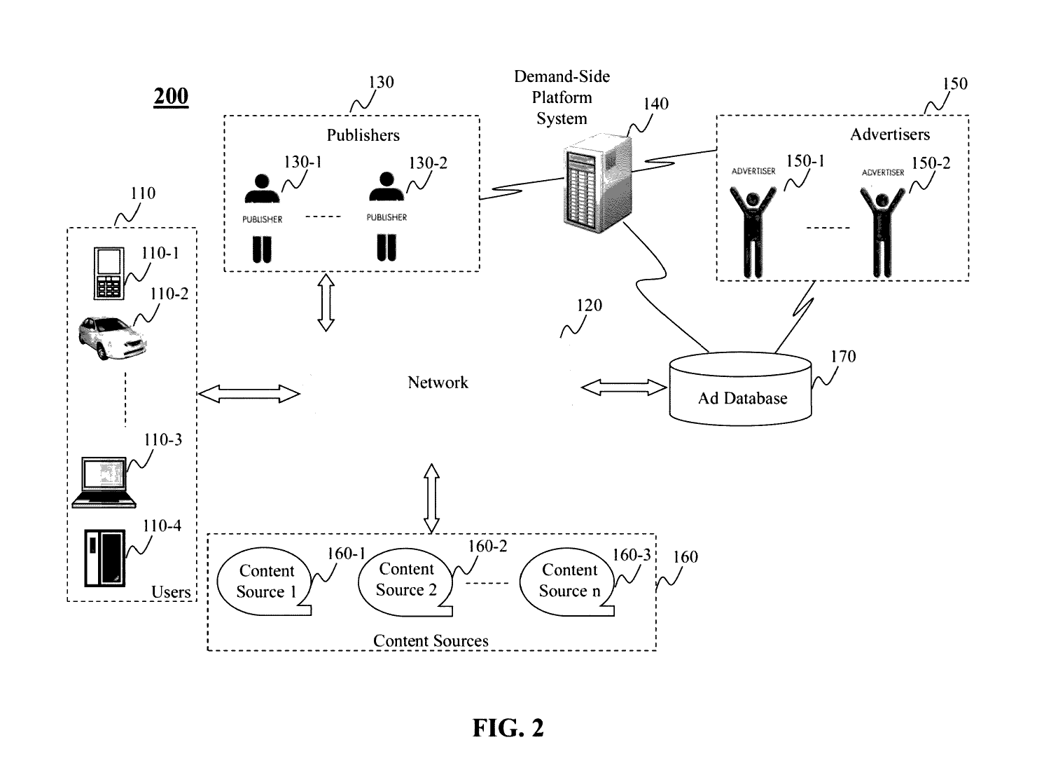

FIG. 2 is a high level depiction of another exemplary networked environment 200 for providing an advertisement to a user, according to an embodiment of the present teaching. The exemplary networked environment 200 in this embodiment is similar to the exemplary networked environment 100 in FIG. 1, except that the demand-side platform system 140 serves as a backend system for one or more publishers 130.

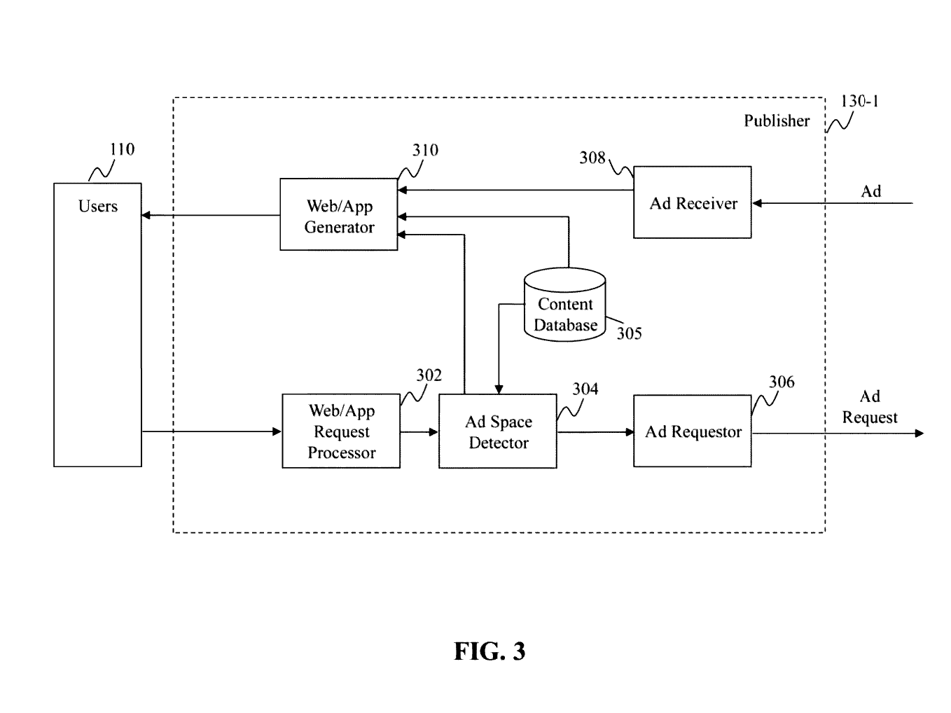

FIG. 3 illustrates an exemplary diagram of a publisher 130-1, according to an embodiment of the present teaching. The publisher 130-1 in this example includes a web/app request processor 302, an ad space detector 304, a content database 305, an ad requestor 306, an ad receiver 308, and a web/app generator 310.

The web/app request processor 302 in this example receives and processes a request from a user. The request may be for a web page or an application provided by the publisher 130-1. The ad space detector 304 in this example can obtain content based on the request for the web page or the application. The content may include information to be included in the web page or application, and/or information about organization or layout of the web page or application. The ad space detector 304 may obtain the content from the content database 305 and/or the content sources 160. The ad space detector 304 may also detect ad spaces, ad opportunities, or ad impressions on the web page or application to be presented to the user, based on the content information.

For example, after the ad space detector 304 detects an ad space, the ad space detector 304 may notify the ad requestor 306 to send an ad request for the ad space. The ad space detector 304 may also notify the web/app generator 310 to wait for an advertisement to be inserted or added into the web page or application.

The ad requestor 306 in this example generates and sends an ad request to DSPs, e.g. the demand-side platform system 140. The ad request may include information about the web/app request from the user and information about the web/app to be presented to the user.

The ad receiver 308 in this example receives advertisements from one or more DSPs in response to the ad request sent by the ad requestor 306. In one embodiment, the advertisements are selected by the DSPs based on the user's explicit interests of advertisements stored in the user's profile. In another embodiment, each advertisement received at the ad receiver 308 is associated with a bid price. Then, the ad receiver 308 can select one of the received advertisements based on their respective bid prices. In yet another embodiment, the ad receiver 308 receives only one advertisement from one DSP. Then, the ad receiver 308 can determine whether to accept this advertisement for presentation with the web page or application, e.g. based on its associated bid price, their previous contract, or the advertisement itself In one example, the ad receiver 308 may receive an ad ID and retrieve an advertisement from the ad database 170 based on the ad ID. After determining and obtaining an advertisement, the ad receiver 308 may send the advertisement to the web/app generator 310 for generating the web page or application.

The web/app generator 310 in this example may generate or update a web page or an application based on the user's request. The web/app generator 310 can receive information about the user's request and information about the ad space(s) detected from the ad space detector 304. The web/app generator 310 may retrieve content needed to generate the web page or application from the content database 305. The web/app generator 310 may also receive determined advertisement(s) to be placed in the detected ad space(s), from the ad receiver 308. Based on the content, ad space(s), and determined advertisement(s), the web/app generator 310 can generate or update the web page or application requested by the user.

The web/app generator 310 may then send the web page or application to the user in response to the user's request. For example, after the user logs in on a web site provided by the publisher 130-1, the publisher 130-1 can provide a homepage customized to the user, where the homepage includes one or more advertisements determined to be interesting to the user.

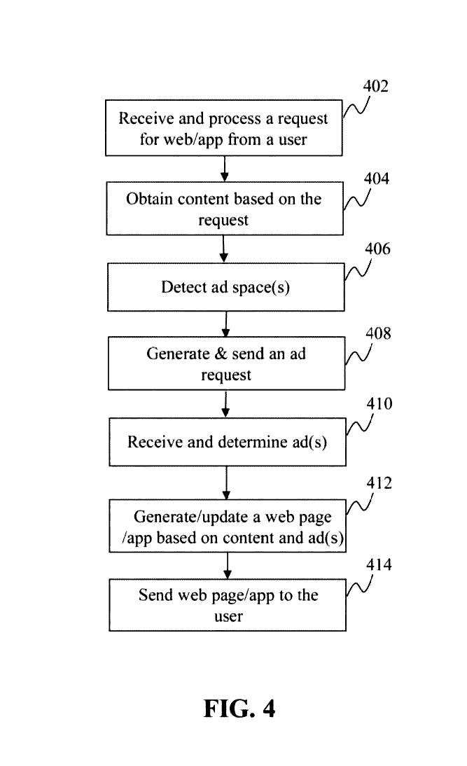

FIG. 4 is a flowchart of an exemplary process performed by a publisher, e.g. the publisher 130-1 in FIG. 3, according to an embodiment of the present teaching. At 402, a request for a web site or an application is received from a user and processed. At 404, content is obtained based on the request. At 406, one or more ad spaces are detected based on the content. At 408, an ad request is generated and sent to a DSP. At 410, advertisements are received in response to the ad request and an advertisement is determined among the received advertisements. At 412, a web page or an application is generated or updated based on the obtained content and the determined advertisement. At 414, the web page or application is sent to the user.

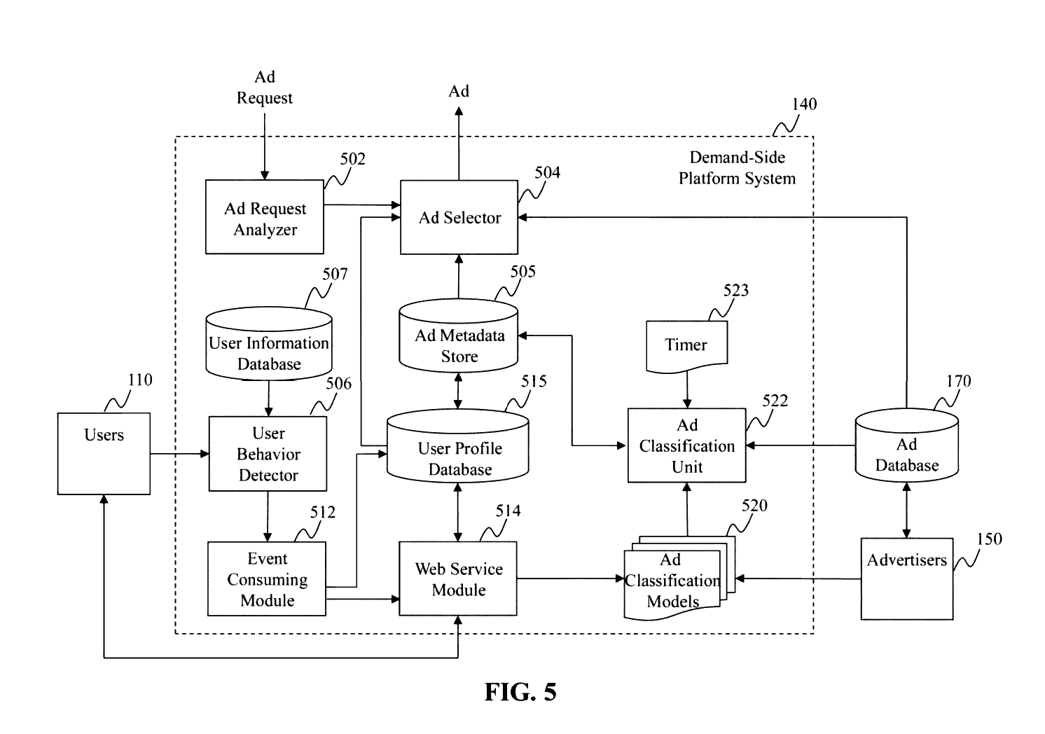

FIG. 5 illustrates an exemplary diagram of a demand-side platform system, e.g. the demand-side platform system 140 in FIG. 1 or FIG. 2, according to an embodiment of the present teaching. The demand-side platform system 140 in this example includes an ad request analyzer 502, an ad selector 504, an ad metadata store 505, a user behavior detector 506, a user information database 507, an event consuming module 512, a web service module 514, a user profile database 515, one or more ad classification models 520, an ad classification unit 522, and a timer 523.

The ad request analyzer 502 in this example receives an ad request from a publisher. The ad request may indicate that there is an ad space available in a web page to be presented to a user. The ad request analyzer 502 may analyze the ad request to determine information about position of the ad space, information about a topic of the web page, information about the user, etc. In one embodiment, the ad request analyzer 502 may determine the user's platform information based on the ad request. For example, the ad request analyzer 502 may determine the user's device, operating system, browser, and/or application used for accessing the web page and potentially clicking an advertisement in the web page. The ad request analyzer 502 may then send the analyzed information to the ad selector 504 for ad selection.

The ad selector 504 in this example selects an advertisement for the user based on the ad request. In one embodiment, the ad selector 504 selects an advertisement based on a user profile associated with the user. The user profile may be stored in the user profile database 515 and include information about the user's preferences about advertisements, information about the user's previously clicked advertisements, etc. The ad selector 504 may also select an advertisement based on metadata related to the advertisement. For example, the metadata may include information about the advertisement's ad ID, ad size, ad position, ad category, etc.

In one embodiment, the ad selector 504 selects an advertisement based on the user's platform information. For example, if the user is using a smartphone with a device ID, the ad selector 504 may select an advertisement similar to advertisements that have been clicked by the user on the smartphone before, regardless of other platform information associated with the user. For example, if the user is using a particular operating system, the ad selector 504 may select an advertisement similar to advertisements that have been clicked by the user through the operating system before, regardless of the devices carrying the operating system. In other examples, the ad selector 504 may select an advertisement similar to advertisements that have been clicked by the user using the same platforms, e.g. same device, same operating system, same browser, and same application.

In one example, after the ad selector 504 selects an advertisement, the ad selector 504 may retrieve the advertisement from the ad database 170, e.g. based on the ad ID of the advertisement. Then, the ad selector 504 can send the retrieved advertisement to the publisher 130-1 in response to the ad request.

In another example, after the ad selector 504 selects an advertisement, the ad selector 504 may send the ad ID of the selected advertisement to the publisher 130-1 in response to the ad request. The publisher 130-1 may then retrieve the advertisement from the ad database 170 based on the ad ID.

The user profile for the user may be created or updated based on processes performed by the user behavior detector 506, the event consuming module 512 and the web service module 514. The user behavior detector 506 in this example detects and analyzes user behavior from a user 110. For example, after a user clicks on an advertisement, the user behavior detector 506 can retrieve user information associated with the user from the user information database 507. The user information may include the user's user ID and demographic information like name, age, sex, address, etc. The user behavior detector 506 may send information about the click event to the event consuming module 512. In other examples, the user may interact with the advertisement in other manners, e.g. scrolling up and down to see the advertisement, bookmarking the advertisement, sharing or forwarding the advertisement to another user, etc. The user behavior detector 506 may also detect the user's other interactions with the advertisement, and send the events related to the other interactions to the event consuming module 512 as well.

The event consuming module 512 in this example receives information about interaction events from the user behavior detector 506. For example, the information may be carried out in form of streaming click data. Based on the streaming click data, the event consuming module 512 may determine platform information related to a click event. The platform information may include information about the user's device, the user's operating system, the user's browser, and/or the user's application used for the click event. The event consuming module 512 may also determine ad related information associated with the click event. The ad related information may include information about the advertisement, e.g. advertisement identity, advertisement size, advertisement position, landing page of the advertisement, advertisement category, etc. The event consuming module 512 can store information about the platform and ad related information into the user profile database 515 in association with the click event. The event consuming module 512 may also send a user profile update request to the web service module 514 for updating the user profile of the user.

The web service module 514 in this example receives the user profile update request from the event consuming module 512 and updates the user profile of the user accordingly. The web service module 514 may generate and provide a user interface to the user. In one embodiment, the user interface may include advertisements previously clicked or accessed by the user on different platforms, e.g. on different devices, at different web sites, or through different applications. In another embodiment, the user interface may include the user's preferences of advertisements, e.g. based on the user's current user profile stored in the user profile database 515. Thus, the web service module 514 can provide cross-platform advertisements to the user via a user interface and receive user inputs from the user via a user interface.

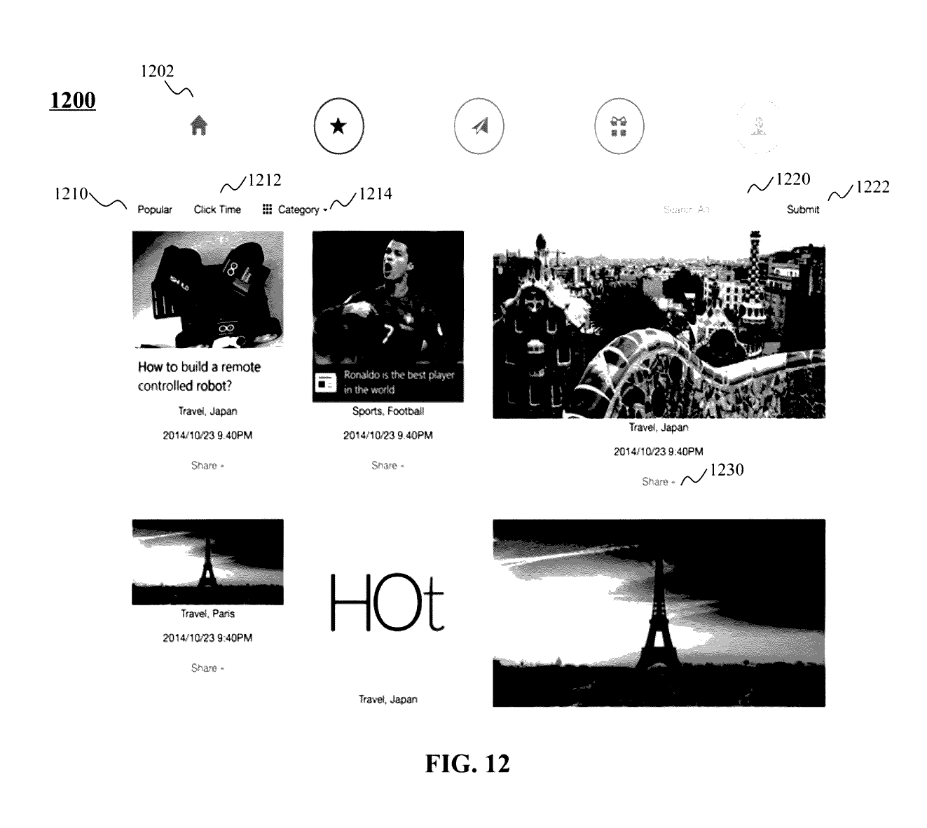

FIG. 12 illustrates an exemplary user interface 1200 for providing advertisements previously accessed by a user to the user, according to an embodiment of the present teaching. The user interface 1200 in this example includes a menu bar where an icon 1202 has been activated to indicate that a homepage is being displayed via the user interface 1200. As illustrated in FIG. 12, the homepage includes different advertisements previously clicked or accessed by the user. The user may have clicked the advertisements on different devices, e.g. a smartphone, a tablet, a laptop, a PC, etc. The user may have clicked the advertisements on different operating systems, e.g. Windows, iOS, Android, etc. The user may have clicked the advertisements via different browsers, e.g. Internet Explorer, Firefox, etc. The user may have clicked the advertisements via different browsers, e.g. Internet Explorer, Firefox, etc. The user may have clicked the advertisements on different websites, e.g. Yahoo.com, cnn.com, etc. The system can collect all of these advertisements, e.g. based on a user ID of the user or a cookie associated with the user. The system can provide them via the user interface 1200, such that the user can view advertisements previously clicked by him/her on different platforms, within one page and via one user interface.

It can be understood that the user may have clicked more advertisements than those displayed in FIG. 12. The user may swipe the screen or scroll up and down to view more advertisements via the user interface 1200. In one embodiment, the user interface 1200 may also include content items (like news), other than advertisements, that have been clicked by the user.

Each advertisement on the user interface 1200 is presented with an image, click time, a category description, and an icon 1230 for sharing. The image may represent an advertisement or news clicked by the user. The click time can record the time when the user clicked the advertisement or news. The category description may indicate a category of the advertisement or news, e.g. Sports, Football; Travel, Paris; etc. The user may click the icon 1230 to share the advertisement or news with another user, e.g. a friend of the user.

The user may rank the advertisements by popularity or click time, e.g. by clicking on icons 1210 and 1212. The user may choose to view advertisements belonging to a particular category, e.g. by clicking on icon 1214. The user may also search for advertisements previously clicked by him/her, e.g. by inputting a search term in the search box 1220 and clicking on icon 1222.

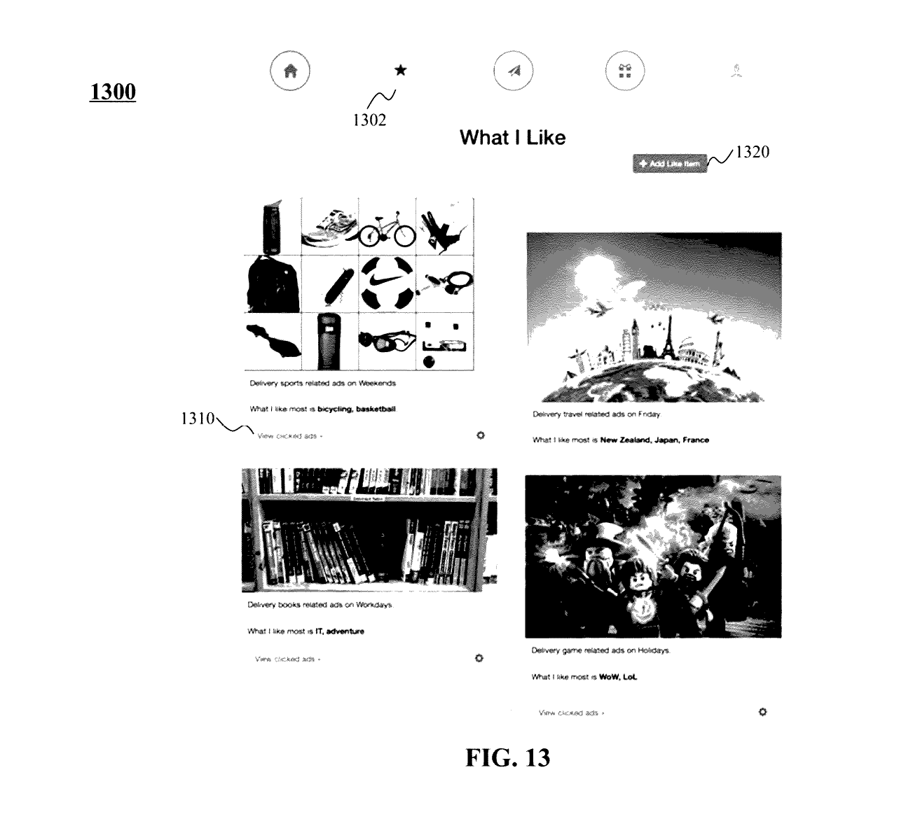

FIG. 13 illustrates an exemplary user interface 1300 for providing a preference of advertisements associated with a user, according to an embodiment of the present teaching. The user interface 1300 in this example includes a menu bar where an icon 1302 has been activated to indicate that a preference page is being displayed via the user interface 1300. As illustrated in FIG. 13, the preference page includes different “like items” each representing a preference of the user regarding advertisements. Each “like item” may include information about advertisements' category and delivery time. For example, the user is interested in books related advertisements on workdays, especially books about IT and adventure. The user is interested in sports related advertisements on weekends, especially bicycling and basketball.

The user may click on a link 1310 associated with a “like item” to view advertisements related to the “like item” and clicked by the user. The “like items” may be listed according their respective creation time. The user may also add an additional “like item” by clicking on an icon 1320.

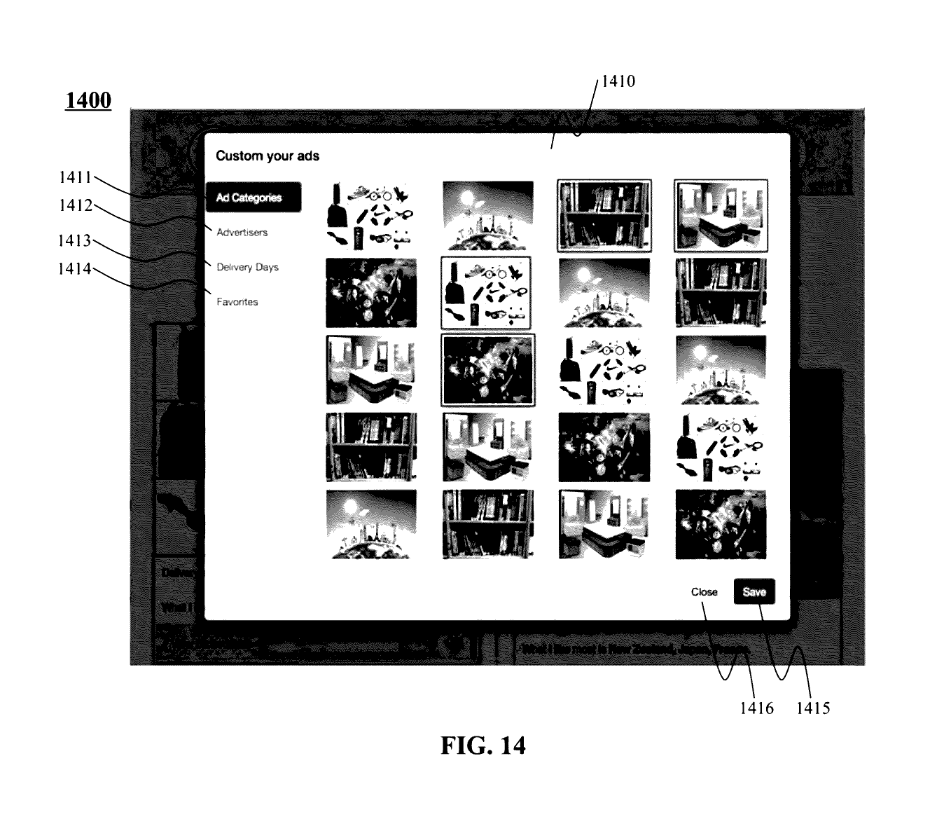

FIG. 14 illustrates an exemplary user interface 1400 for a user to customize his/her preference of advertisements, according to an embodiment of the present teaching. In one embodiment, the user interface 1400 may be provided to the user after the user clicked on the icon 1320 in the user interface 1300 shown in FIG. 13.

As illustrated in FIG. 14, the user interface 1400 includes a pop-up window 1410 for the user to customize his/her advertisement setting, e.g. by adding or modifying a “like item.” The pop-up window 1410 in this example includes four icons: “ad categories” 1411, “advertisers” 1412, “delivery days” 1413, and “favorites” 1414. As shown in FIG. 14, the “ad categories” 1411 is activated, and the user is selecting categories of ads preferred by him/her for the “like item.” The user may activate the “advertisers” 1412 to select one or more advertisers from whom he/she prefers to receive ads belonging to the categories. The user may also activate the “delivery days” 1413 to indicate days on which he/she prefers to receive the ads associated with the “like item.” The user may also activate the “favorites” 1414 to indicate his favorite topics of ads within the selected ad categories associated with the “like item.” After the user makes his/her selections, the user can save the changes by clicking on icon 1415 and close the window 1410 by clicking on icon 1416. Accordingly, one more “like item” may be displayed via the user interface 1300. In one embodiment, a “like item” in the user interface 1300 may be modified based on the process described above regarding FIG. 14. It can be understood that the pictures and images displayed in FIGS. 12-14 are for illustration purposes only and do not mean to limit the present teaching in any sense.

Referring back to FIG. 5, the web service module 514 in this example can determine ad preference settings for a user based on user inputs, e.g. via the user interfaces in FIGS. 12-14. Based on the determined ad settings, the web service module 514 may retrieve a user profile of the user from the user profile database 515 and update the user profile, e.g. after the user adds a like item as illustrated in FIG. 14. The web service module 514 may then store the updated user profile into the user profile database 515. The user profile may include updated information about the user's preferences regarding advertisements, e.g. in form of “like items” shown in FIG. 13.

The web service module 514 may also generate information to update the ad classification models 520. An ad classification model may indicate how to assign an advertisement into a category. For example, according to an ad classification model, an advertisement should be assigned to a travel category because the advertisement is related to a service used for travel. For example, according to another ad classification model, an advertisement should be assigned to a book category because the advertisement has been clicked most frequently on web sites related to books. For example, according to another ad classification model, an advertisement should be assigned to sports category because the advertisement has been clicked by most users having interest in sports. The ad classification models 520 may come from the advertisers 150 and can be updated by the web service module 514.

The ad classification unit 522 in this example may classify ads in the ad database 170 based on the ad classification models 520. In one example, the ad classification unit 522 can select one of the ad classification models 520 and use it to classify all advertisements in the ad database 170. In another example, the ad classification unit 522 can switch to another ad classification model after a period of time, based on time information provided by the timer 523.

As the advertisements in the ad database 170 may be updated from time to time, the ad classification unit 522 can classify the advertisements periodically, e.g. every week or every month. In one example, after a period of time based on the timer 523, the ad classification unit 522 can re-classify all the advertisements in the ad database 170. After each classification, the ad classification unit 522 may generate and store metadata related to the classified advertisements into the ad metadata store 505. The ad metadata store 505 in this example includes information related to advertisements and is connected to the user profile database 515.

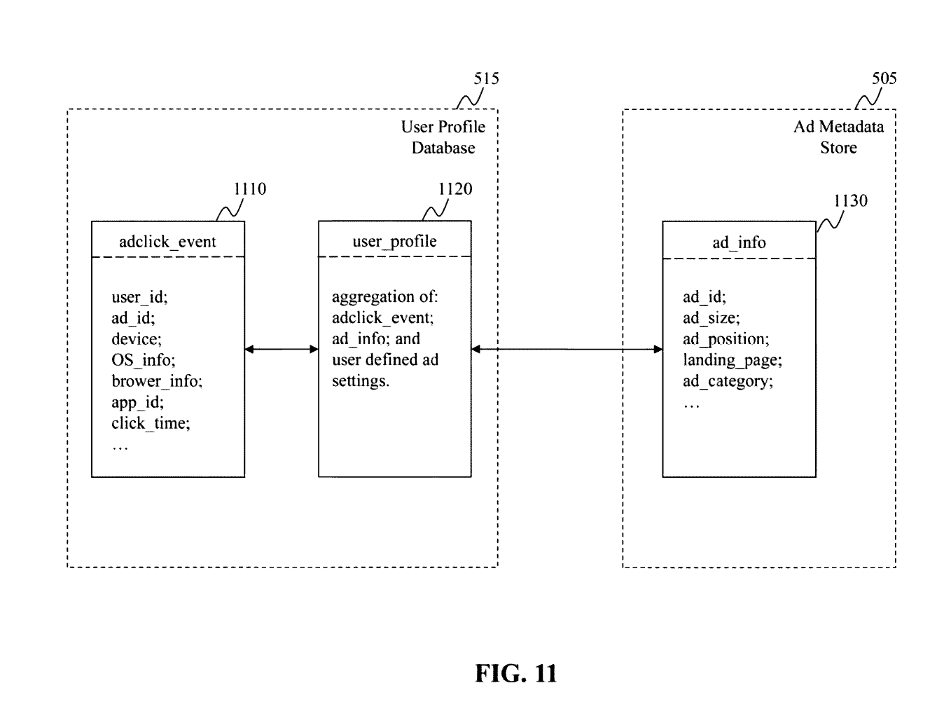

FIG. 11 illustrates exemplary structures of a user profile database 515 and an ad metadata store 505, according to an embodiment of the present teaching. As shown in FIG. 11, the user profile database 515 and the ad metadata store 505 are connected to each other.

The ad metadata store 505 includes information about advertisements 1130. For example, each advertisement may have associated metadata including but not limited to an ad ID, ad size, a landing page, ad position in the landing page, ad category, etc. As discussed above, the ad category can be determined by the ad classification unit 522 based on an ad classification model.

The user profile database 515 includes information about ad click events 1110 and information about user profiles 1120. An ad click event may be triggered by a user clicking on an advertisement. The ad click event can be recorded in the user profile database 515 with information about the user, the advertisement, and the clicking. For example, the ad click event may be recorded with the user's user ID, the advertisement's ad ID, click time, the user's device, operating system, browser and application used for the clicking, etc. The user profile database 515 may also include information about user profiles. A user profile for a user may be generated by an aggregation of ad click events associated with the user, ad information associated with the ad click events, and user defined ad settings based on e.g. user inputs received via the user interface in FIG. 14.

The user profile database 515 can be cross-indexed with the ad metadata store 505. For example, an ad ID may be both included in the user profile database 515 in association with an ad click event and/or a user profile and included in the ad metadata store 505 in association with ad information for an ad.

Referring back to FIG. 5, after receiving an ad request for a user, the ad selector 504 may determine a user ID for the user. Based on the user ID, the ad selector 504 may retrieve a user profile for the user from the user profile database 515. Based on the user profile, the ad selector 504 may determine the user's preferences of advertisements at that time. For example, when that day is Saturday, the ad selector 504 may determine that the user prefers travel related ads. The ad selector 504 may then retrieve metadata associated with travel related ads from the ad metadata store 505 and select one or more travel related ads.

Based on the selection, the ad selector 504 may retrieve the selected ads from the ad database 170 and send them to the publisher 130-1 for presentation to the user. In another case, the ad selector 504 may just send metadata or ad IDs about the selected advertisements to the publisher 130-1, such that the publisher 130-1 may retrieve the selected ads from the ad database 170 for presentation to the user.

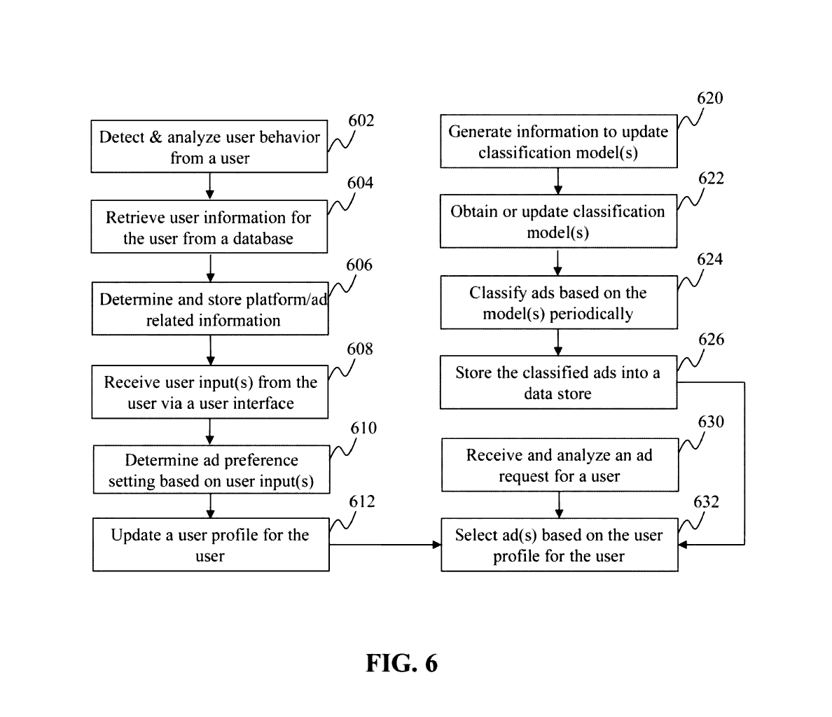

FIG. 6 is a flowchart of an exemplary process performed by a demand-side platform system, e.g. the demand-side platform system 140 in FIG. 5, according to an embodiment of the present teaching. At 602, user behaviors from a user are detected and analyzed. At 604, user information for the user is retrieved from a database. At 606, information related to platform and advertisement is determined and stored, e.g. based on a click of the user regarding an advertisement. The platform information may include device, operating system, browser and application used by the user to click the advertisement. The information related to the advertisement may include category of the ad, landing page of the ad, position of the ad, an ad ID of the ad, etc.

At 608, user inputs are received from the user, e.g. via the user interface 1400 in FIG. 14. The user inputs are analyzed at 610 to determine ad preference setting for the user. For example, the ad preference setting may indicate that the user prefers advertisements belonging to sports category during weekends, with basketball advertisements or news being his/her favorite. At 612, a user profile for the user is updated or added based on the user inputs, e.g. as illustrated in FIG. 14. The process then goes to 632.

The demand-side platform system 140 may receive and analyze an ad request for a user at 630. Then, the process goes to 632 to select one or more ads based on the user profile for the user.

At 620, information is generated to update ad classification models. At 622, ad classification models are obtained or updated. At 624, advertisements are classified based on an ad classification model, e.g. periodically. At 626, the classified ads are stored into a data store. The process then goes to 632 to select ads.

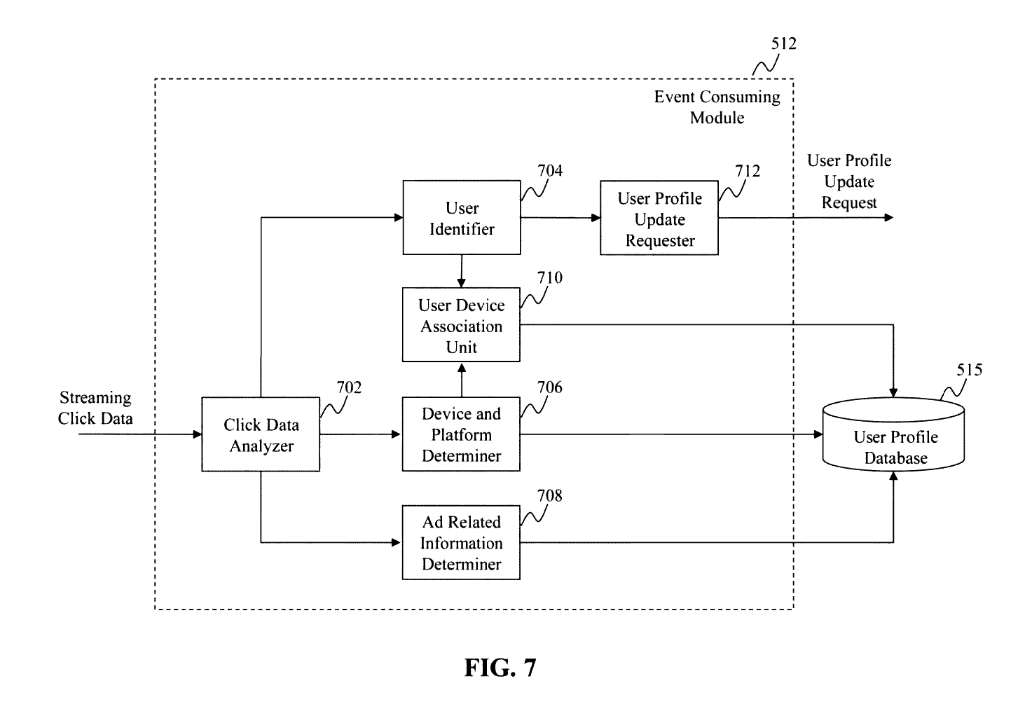

FIG. 7 illustrates an exemplary diagram of an event consuming module 512, according to an embodiment of the present teaching. The event consuming module 512 in this example includes a click data analyzer 702, a user identifier 704, a user device association unit 710, a device and platform determiner 706, an ad related information determiner 708, and a user profile update requester 712.

The click data analyzer 702 in this example receives and analyzes streaming click data from the user behavior detector 506. The streaming click data include information about users' clicks on advertisements or news or other content items on a web page or application provided by a publisher. In one embodiment, the streaming click data may include information about an advertisement clicked by one user and shared with another user. In another embodiment, the click data analyzer 702 may also receive streaming data about users' other interactions with a content item, e.g. dwelling an ad for longer than a given time period, zooming in and out a news, etc. The system may process the streaming data in a similar way as processing the streaming click data. The click data analyzer 702 can send the analyzed streaming click data to the user identifier 704, the device and platform determiner 706, and the ad related information determiner 708.

The user identifier 704 in this example may identify a user based on streaming click data associated with the user. In one example, the user identifier 704 may determine the user's user ID. In another example, the user identifier 704 may determine a temporary cookie for the user to identify the user. The user identifier 704 may send the user's identification information to the user profile update requester 712 for updating a user profile of the user. The user identifier 704 may also send the user's identification information to the user device association unit 710 for association of the user's devices.

The device and platform determiner 706 in this example may determine platform and/or device information associated with click events based on the streaming click data. For example, for a user clicking on different ads, the device and platform determiner 706 may determine that the user clicked the ads on a smartphone with a particular device ID. In other examples, the device and platform determiner 706 may determine that the user clicked the ads via a particular operating system or particular application with a unique ID. The device and platform determiner 706 can send the particular device ID (or other unique ID indicating a particular platform) to the user device association unit 710 for user device association. The device and platform determiner 706 may store the device/platform information into the user profile database 515.

The user device association unit 710 in this example may receive user identification information, e.g. a user ID, for a user from the user identifier 704 and receive a particular device ID associated with the user from the device and platform determiner 706. The user device association unit 710 may then associate them. For example, the user device association unit 710 may determine that a user ID is associated with a particular device ID. As such, when the system detects the device ID, the system can determine that a user having the user ID is using the device, even if the user ID has not been detected. This may happen when the user is using a new application on the device to view web pages and advertisement, such that the user has not logged in with the user ID. Based on the user device association, the advertisements clicked by the user on the device can be collected together by the system in association with the user, whether the user ID is detected or not.

Similarly, the user device association unit 710 may determine that a user ID is associated with a particular operating system ID or a particular browser ID, e.g. a serial number related to software. Then, the advertisements clicked by the user via the particular operating system or particular browser can be collected in association with the user, whether the user ID is detected or not.

The user device association unit 710 may store the user device association information into the user profile database 515, such that a user profile for the user can be created based on all advertisements clicked by the user, e.g. on different devices with a same user ID, on a same device associated with the user ID, on different operating systems, on different web sites, etc. The system can determine an advertisement or news has been clicked by a user, either based on a detected user ID or based on a detected device ID or serial number that is associated with the user ID.

The ad related information determiner 708 in this example may determine ad related information based on the streaming click data for a user. For example, the ad related information may include categories, landing pages, positions, sizes of the advertisements clicked by the user. The ad related information determiner 708 may store the ad related information into the user profile database 515. As discussed before, the ad related information may be stored in association with a user ID, either based on the detected user ID or based on detected device ID or serial numbers associated with the user ID.

The user profile update requester 712 in this example generates and sends a request to update a user profile for a user, based on the user's identification information from the user identifier 704. The user profile update requester 712 sends the request to the web service module 514 for updating the user profile. This may be due to configuration of the system, where a user profile for a user should be updated when the user clicks on an advertisement or when the user have clicked on more than a pre-determined number of advertisements. In one embodiment, the update of the user profile is triggered not by the request, but by timing information as discussed later.

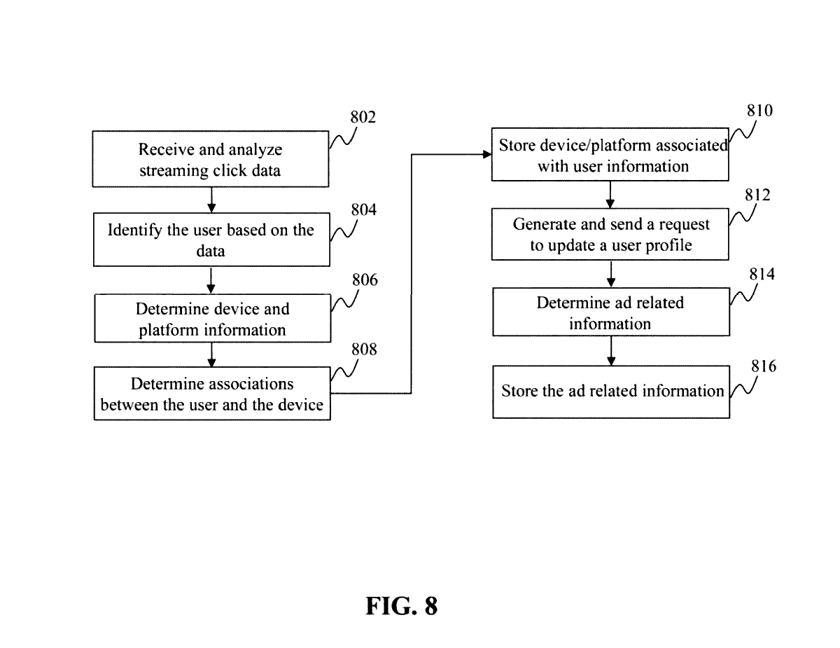

FIG. 8 is a flowchart of an exemplary process performed by an event consuming module, e.g. the event consuming module 512 in FIG. 7, according to an embodiment of the present teaching. At 802, streaming click data are received and analyzed. At 804, the user is identified based on the data. At 806, device and platform information is determined. At 808, associations between the user and the device (or platforms) are determined. At 810, device/platform information is stored associated with user information of the user. At 812, a request is generated and sent to update a user profile for the user. At 814, ad related information for the user is determined. At 816, the ad related information is stored.

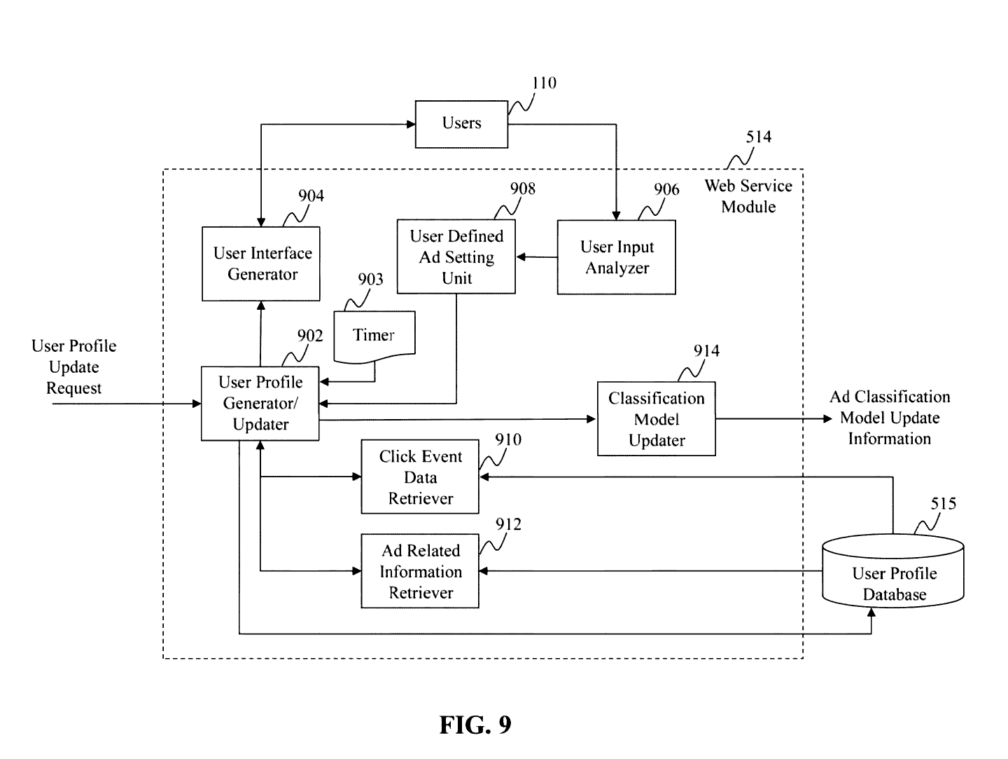

FIG. 9 illustrates an exemplary diagram of a web service module 514, according to an embodiment of the present teaching. The web service module 514 in this example includes a user profile generator/updater 902, a timer 903, a user interface generator 904, a user input analyzer 906, a user defined ad setting unit 908, a click event data retriever 910, an ad related information retriever 912, and a classification model updater 914.

The user profile generator/updater 902 in this example may receive a request to update a user profile for a user. The request may include information about new click events associated with the user. The user profile generator/updater 902 may determine to update the user profile upon the request. In one embodiment, the user profile generator/updater 902 may determine to update the user profile based on timing information provided by the timer 903. For example, the user profile generator/updater 902 may update the user profile every day, every week, or every month. In another embodiment, the user profile generator/updater 902 may determine to update the user profile based on a new ad preference setting for the user, provided by the user defined ad setting unit 908.

After determining to update the user profile for the user, the user profile generator/updater 902 may notify the click event data retriever 910 to retrieve click event data for the user from the user profile database 515 and notify the ad related information retriever 912 to retrieve ad related information for the user from the user profile database 515. The user profile generator/updater 902 may then update the user profile based on the user profile update request and store the updated user profile back to the user profile database 515.

In one embodiment, after receiving the user profile update request or after a pre-determined period of time, the user profile generator/updater 902 may notify the user interface generator 904 to generate a user interface that includes advertisements previously clicked or accessed by the user via different platforms, e.g. the user interface 1200 in FIG. 12. The user interface generator 904 may provide the user interface to the user, such that the user can review all advertisements previously clicked by him/her or advertisements previously clicked by him/her within a given time period, e.g. last week or last month.

The user interface generator 904 in this example may generate and provide a user interface to a user. As discussed above, the user interface generator 904 may generate and provide the user interface 1200 to a user for the user to review previously clicked ads.

In one embodiment, the user interface generator 904 may receive a request from a user 110 to define or update ad preference setting for the user 110. The user interface generator 904 may then generate and provide the user interface 1300 as shown in FIG. 13 to the user, such that the user can review ad preference settings generated for the user based on the user's previous inputs.

As discussed above, the user may add or modify a “like item” in the ad preference setting shown in the user interface 1300, by entering some user inputs via the user interface 1400 shown in FIG. 14. The user input analyzer 906 in this example receives and analyzes the user inputs from the user. The user input analyzer 906 can send information related to the user inputs to the user defined ad setting unit 908.

The user defined ad setting unit 908 in this example can determine ad preference setting for the user based on the user inputs. For example, the user defined ad setting unit 908 can update a “like item” in the FIG. 13 based on some user inputs that indicate a change of ad category or a change of delivery dates. The user defined ad setting unit 908 may also add a “like item” in the FIG. 13 based on some user inputs that indicate a new ad preference setting via the user interface 1400 in FIG. 14. The user defined ad setting unit 908 may send the updated ad preference setting about the user to the user profile generator/updater 902 to update the user profile based on the ad preference setting.

In addition to updating the user profile, the user profile generator/updater 902 may also notify the classification model updater 914 to generate and send information to update an ad classification model. The classification model updater 914 in this example may generate some information based on updated user profiles for updating an ad classification model. For example, based on updated user profiles, more and more users are interested in sports. Then the classification model updater 914 can generate update information to require updating an ad classification model to classify ads with more detailed topics within the category of sports or separating the sports category into multiple categories.

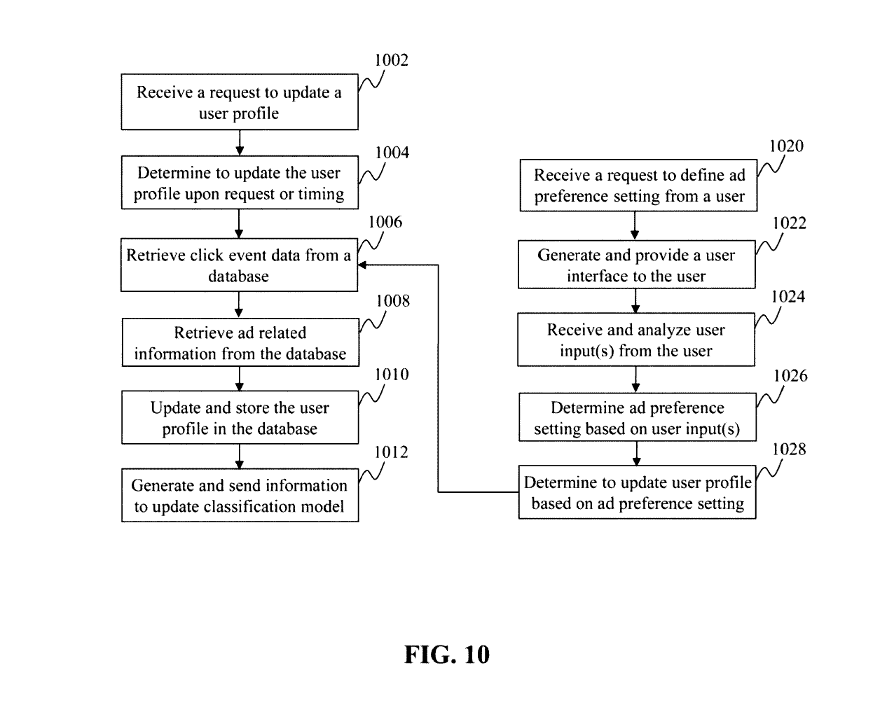

FIG. 10 is a flowchart of an exemplary process performed by a web service module, e.g. the web service module 514 in FIG. 9, according to an embodiment of the present teaching. At 1002, a request is received to update a user profile. At 1004, it is determined to update the user profile upon request or based on timing. The process then goes to 1006.

At 1020, a request is received from a user to define ad preference setting for the user. At 1022, a user interface is generated and provided to the user. At 1024, user inputs are received from the user via the user interface and analyzed. At 1026, ad preference setting is determined based on the user inputs. At 1028, it is determined to update the user profile based on the ad preference setting. The process then goes to 1006.

At 1006, click event data are retrieved from a database. At 1008, ad related information is retrieved from the database. At 1010, the user profile is updated and stored in the database. Optionally at 1012, information is generated and sent to update an ad classification model.

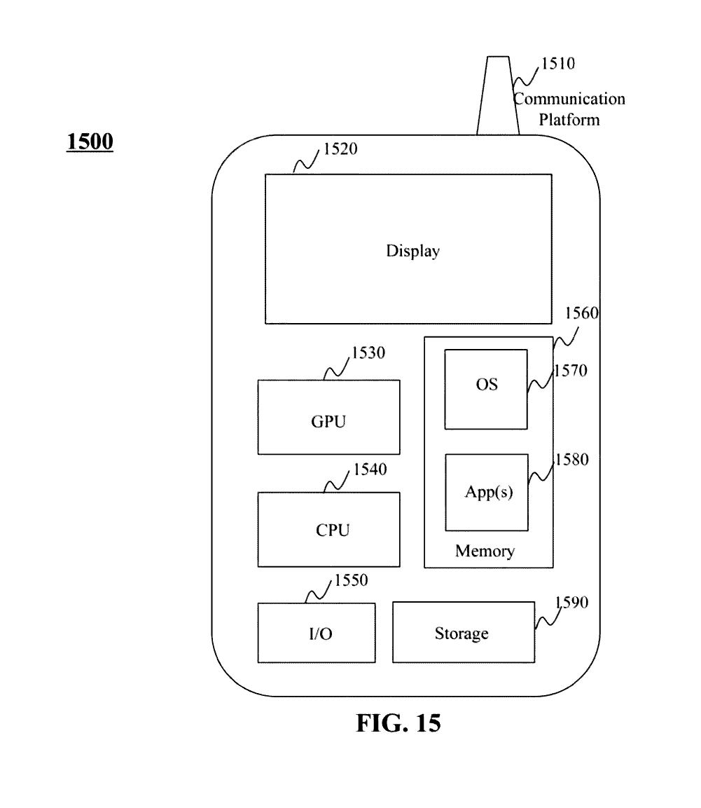

FIG. 15 depicts the architecture of a mobile device which can be used to realize a specialized system implementing the present teaching. In this example, the user device on which content and user profile are presented and interacted-with is a mobile device 1500, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1500 in this example includes one or more central processing units (CPUs) 1540, one or more graphic processing units (GPUs) 1530, a display 1520, a memory 1560, a communication platform 1510, such as a wireless communication module, storage 1590, and one or more input/output (I/O) devices 1550. Any other suitable component, including but not limited to a system bus or a controller (not shown), may also be included in the mobile device 1500. As shown in FIG. 15, a mobile operating system 1570, e.g., iOS, Android, Windows Phone, etc., and one or more applications 1580 may be loaded into the memory 1560 from the storage 1590 in order to be executed by the CPU 1540. The applications 1580 may include a browser or any other suitable mobile apps for receiving advertisements on the mobile device 1500. User interactions with the advertisements or other content items may be achieved via the I/O devices 1550 and provided to the demand-side platform system 140 and/or other components of systems 100 and 200, e.g., via the network 120.

To implement various modules, units, and their functionalities described in the present disclosure, computer hardware platforms may be used as the hardware platform(s) for one or more of the elements described herein (e.g., the demand-side platform system 140 and/or other components of systems 100 and 100 described with respect to FIGS. 1-14). The hardware elements, operating systems and programming languages of such computers are conventional in nature, and it is presumed that those skilled in the art are adequately familiar therewith to adapt those technologies to selecting and providing an advertisement to a user as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

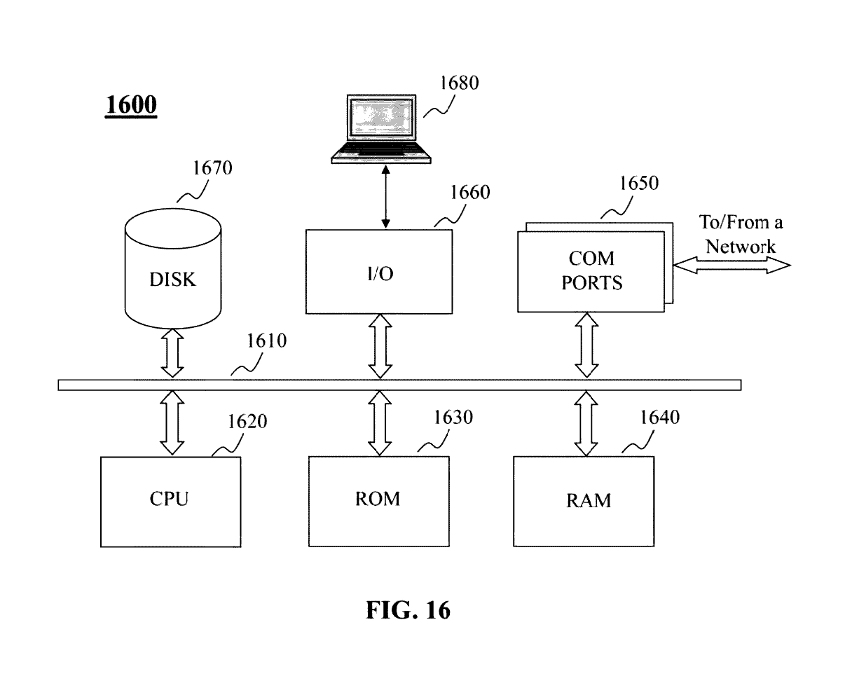

FIG. 16 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1600 may be used to implement any component of the cross-platform advertisement selection techniques, as described herein. For example, the demand-side platform system 140, etc., may be implemented on a computer such as computer 1600, via its hardware, software program, firmware, or a combination thereof. Although only one such computer is shown, for convenience, the computer functions relating to cross-platform advertisement selection as described herein may be implemented in a distributed fashion on a number of similar platforms, to distribute the processing load.

The computer 1600, for example, includes COM ports 1650 connected to and from a network connected thereto to facilitate data communications. The computer 1600 also includes a central processing unit (CPU) 1620, in the form of one or more processors, for executing program instructions. The exemplary computer platform includes an internal communication bus 1610, program storage and data storage of different forms, e.g., disk 1670, read only memory (ROM) 1630, or random access memory (RAM) 1640, for various data files to be processed and/or communicated by the computer, as well as possibly program instructions to be executed by the CPU. The computer 1600 also includes an I/O component 1660, supporting input/output flows between the computer and other components therein such as user interface elements 1680. The computer 1600 may also receive programming and data via network communications.

Hence, aspects of the methods of cross-platform advertisement selection, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a DSP into the hardware platform(s) of a computing environment or other system implementing a computing environment or similar functionalities in connection with cross-platform advertisement selection. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the cross-platform advertisement selection as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for providing an advertisement to a user, the method comprising:
obtaining data associated with the user through a plurality of platforms;
determining one or more advertisements accessed by the user based on the data;
creating a user profile associated with the user based on the one or more advertisements and the platforms;
detecting one of the platforms through which the user is accessing the network; and
providing an advertisement to the user based on the user profile and the detected platform.

2. The method of claim 1, wherein the platforms are heterogeneous platforms that include information about at least one of: device, operating system, browser, web site, and application.

3. The method of claim 1, wherein the user profile is created based on at least one of:
a user profile of another user who has accessed one or more advertisements that are similar to the one or more advertisements accessed by the user; and
one or more shared advertisements that are accessed by one or more other users and shared with the user by the one or more other users.

4. The method of claim 1, wherein the creating comprises:
determining first information about the one or more advertisements, wherein the first information includes information about at least one of: advertisement identity, advertisement size, landing page of advertisement, advertisement position on the landing page, and advertisement category;
determining second information about the user's access of the one or more advertisements, wherein the second information includes information about at least one of: user identity, advertisement identity, access time, and the platforms; and
creating the user profile based on the first information and the second information.

5. The method of claim 1, further comprising providing the user profile to the user, such that the user is presented simultaneously information about the one or more advertisements accessed by the user via the plurality of platforms.

6. The method of claim 5, further comprising:
obtaining one or more inputs from the user, wherein the one or more inputs indicate the user's preference regarding advertisements; and
updating the user profile based on the one or more inputs.

7. The method of claim 6, wherein the user's preference includes information about at least one of: when to provide an advertisement, frequency to provide an advertisement, category of an advertisement, size of an advertisement, and position of an advertisement.

8. A system having at least one processor, storage, and a communication platform connected to a network for providing an advertisement to a user, comprising:
a user behavior detector configured for obtaining data associated with the user through a plurality of platforms;
an event consuming module configured for determining one or more advertisements accessed by the user based on the data;
a web service module configured for creating a user profile associated with the user based on the one or more advertisements and the platforms;
an ad request analyzer configured for detecting one of the platforms through which the user is accessing the network; and
an ad selector configured for providing an advertisement to the user based on the user profile and the detected platform.

9. The system of claim 8, wherein the platforms are heterogeneous platforms that include information about at least one of: device, operating system, browser, web site, and application.

10. The system of claim 8, wherein the user profile is created based on at least one of:
a user profile of another user who has accessed one or more advertisements that are similar to the one or more advertisements accessed by the user; and
one or more shared advertisements that are accessed by one or more other users and shared with the user by the one or more other users.

11. The system of claim 8, wherein the web service module comprises:
an ad related information retriever configured for determining first information about the one or more advertisements, wherein the first information includes information about at least one of: advertisement identity, advertisement size, landing page of advertisement, advertisement position on the landing page, and advertisement category;
a click event data retriever configured for determining second information about the user's access of the one or more advertisements, wherein the second information includes information about at least one of: user identity, advertisement identity, access time, and the platforms; and
a user profile generator/updater configured for creating the user profile based on the first information and the second information.

12. The system of claim 8, wherein the web service module comprises a user interface generator configured for:
generating a user interface; and
providing the user profile to the user via the user interface, such that the user is presented simultaneously information about the one or more advertisements accessed by the user via the plurality of platforms.

13. The system of claim 12, wherein:
the web service module further comprises a user input analyzer configured for obtaining one or more inputs from the user;
the one or more inputs indicate the user's preference regarding advertisements; and
the user profile generator/updater is further configured for updating the user profile based on the one or more inputs.

14. The system of claim 13, wherein the user's preference includes information about at least one of: when to provide an advertisement, frequency to provide an advertisement, category of an advertisement, size of an advertisement, and position of an advertisement.

15. A machine-readable, non-transitory and tangible medium having information recorded thereon for providing an advertisement to a user, the information, when read by the machine, causes the machine to perform the following:
obtaining data associated with the user through a plurality of platforms;
determining one or more advertisements accessed by the user based on the data;
creating a user profile associated with the user based on the one or more advertisements and the platforms;
detecting one of the platforms through which the user is accessing the network; and
providing an advertisement to the user based on the user profile and the detected platform.

16. The medium of claim 15, wherein the platforms are heterogeneous platforms that include information about at least one of: device, operating system, browser, web site, and application.

17. The medium of claim 15, wherein the user profile is created based on at least one of:
a user profile of another user who has accessed one or more advertisements that are similar to the one or more advertisements accessed by the user; and
one or more shared advertisements that are accessed by one or more other users and shared with the user by the one or more other users.

18. The medium of claim 15, wherein the creating comprises:
determining first information about the one or more advertisements, wherein the first information includes information about at least one of: advertisement identity, advertisement size, landing page of advertisement, advertisement position on the landing page, and advertisement category;
determining second information about the user's access of the one or more advertisements, wherein the second information includes information about at least one of:
user identity, advertisement identity, access time, and the platforms; and
creating the user profile based on the first information and the second information.

19. The medium of claim 15, wherein the information, when read by the machine, further causes the machine to perform providing the user profile to the user, such that the user is presented simultaneously information about the one or more advertisements accessed by the user via the plurality of platforms.

20. The medium of claim 19, wherein the information, when read by the machine, further causes the machine to perform the following:
obtaining one or more inputs from the user, wherein the one or more inputs indicate the user's preference regarding advertisements; and
updating the user profile based on the one or more inputs.

21. The medium of claim 20, wherein the user's preference includes information about at least one of: when to provide an advertisement, frequency to provide an advertisement, category of an advertisement, size of an advertisement, and position of an advertisement.
